(19) United States
(12) Patent Application Publication
(10) Pub. No.: US 2025/0383655 A1
(43) Pub. Date: Dec. 18, 2025

(54) SEMICONDUCTOR PROCESS TRAINING METHOD AND ELECTRONIC DEVICE PERFORMING THEREOF

(71) Applicant: LEtuiN Edu Co., Ltd, Seoul (KR)

(72) Inventors: JUNHO KIM, Seoul (KR); -ye-rin Kwon, Seoul (KR); Jeong won SEO, Seoul (KR)

(21) Appl. No.: 19/197,123

(22) Filed: May 2, 2025

(30) Foreign Application Priority Data
Jun. 14, 2024 (KR) 10-2024-0077794
Mar. 27, 2025 (KR) 10-2025-0039290

(51) Int. Cl. G05B 19/418

(52) U.S. Cl. CPC G05B 19/41885; G05B 19/41865; G05B 2219/45031

(57) ABSTRACT

The method performed by an electronic device may include: outputting monitoring data of a target scenario among one or more predetermined scenarios related to simulation errors, in a production mode of a semiconductor process simulation based on test data input by a user; switching from the production mode of the semiconductor process simulation to a maintenance mode; and terminating the target scenario when a user input related to simulation maintenance satisfies a maintenance condition of the target scenario while in the maintenance mode.

### FIELD OF THE INVENTION

The present disclosure relates to a method of providing semiconductor process training through an electronic device based on extended reality (XR). More specifically, the present disclosure relates to a method that enables effective learning of semiconductor manufacturing processes in a virtual training environment, and an electronic device to which the method is applied.

### BACKGROUND

Extended reality (XR), which encompasses virtual reality (VR), augmented reality (AR), and mixed reality (MR), has recently been utilized across various industries such as education, healthcare, and manufacturing (e.g., smart factories). Users can have immersive experiences through XR-based devices (e.g., smart glasses, head-mounted displays, and portable user terminals) by interacting with virtual digital content, physical environments, and/or hybrid content combining the two.

Meanwhile, semiconductor processes consist of extremely complex and precise steps, requiring advanced expertise and skilled techniques. Due to the nature of the semiconductor industry, providing hands-on training using actual equipment beyond theoretical education involves high costs and large spaces, along with safety constraints for both the environment and human health. Therefore, there is a need for a method that can provide practical and concrete semiconductor process training while overcoming spatial and temporal limitations.

### SUMMARY

A method performed by an electronic device according to one embodiment can provide an environment in which a user can directly simulate and practice various semiconductor processes by virtually reproducing a semiconductor process environment using XR technology.

The method performed by an electronic device according to one embodiment can provide a user learning semiconductor processes with training content including various troubleshooting scenarios.

The technical problems of the present disclosure are not limited to the above-mentioned problems, and other technical problems not mentioned will be clearly understood by those skilled in the art from the description below.

A method performed by an electronic device according to one embodiment may include: in a production mode of a semiconductor process simulation based on test data derived from user input, outputting monitoring data of a target scenario among one or more predetermined scenarios related to simulation errors; switching from the production mode of the semiconductor process simulation to a maintenance mode; and in the maintenance mode, terminating the target scenario when user input related to simulation maintenance satisfies the maintenance condition of the target scenario.

In one embodiment, the monitoring data of the target scenario may include visual data related to the predetermined simulation error information of the target scenario.

In one embodiment, the visual data may include numerical data, image data, or text data representing the predetermined simulation error information of the target scenario.

In one embodiment, each of the one or more predetermined scenarios may include predetermined simulation error information and maintenance information corresponding to the simulation error information.

In one embodiment, the maintenance information may include test data information corresponding to parameters related to the semiconductor process simulation.

In one embodiment, the maintenance information may include component replacement information of virtual equipment related to the semiconductor process simulation.

In one embodiment, the maintenance information may include component adjustment information of virtual equipment related to the semiconductor process simulation.

In one embodiment, the maintenance information may include user action information related to the semiconductor process simulation.

In one embodiment, the operation of terminating the target scenario when the user input related to simulation maintenance satisfies the maintenance condition of the target scenario may include terminating the target scenario when the user input corresponds to the maintenance information of the target scenario.

In one embodiment, the method may further include: after terminating the target scenario, switching back to the production mode of the semiconductor process simulation; and outputting visual data indicating normal operation of the semiconductor process simulation in the production mode.

A non-transitory computer-readable storage medium according to one embodiment stores one or more programs including instructions, and when the instructions are executed individually or collectively by at least one processor of an electronic device, cause the electronic device to: in a production mode of a semiconductor process simulation based on test data derived from user input, output monitoring data of a target scenario among one or more predetermined scenarios related to simulation errors; switch from the production mode of the semiconductor process simulation to a maintenance mode; and in the maintenance mode, terminate the target scenario when user input related to simulation maintenance satisfies the maintenance condition of the target scenario.

An electronic device according to one embodiment may include: at least one processor including processing circuitry; and a memory including one or more storage media storing instructions, wherein the instructions, when executed individually or collectively by the at least one processor, cause the electronic device to: in a production mode of a semiconductor process simulation based on test data derived from user input, output monitoring data of a target scenario among one or more predetermined scenarios related to simulation errors; switch from the production mode of the semiconductor process simulation to a maintenance mode; and in the maintenance mode, terminate the target scenario when user input related to simulation maintenance satisfies the maintenance condition of the target scenario.

### BRIEF DESCRIPTION OF THE DRAWINGS

FIG. 1 is a schematic diagram illustrating a semiconductor process training system according to an embodiment of the present disclosure.

FIG. 2 is a block diagram illustrating the configuration of an electronic device according to an embodiment of the present disclosure.

FIG. 3 is a diagram illustrating various examples of visual data according to the present disclosure.

FIG. 4 is another diagram illustrating various examples of visual data according to the present disclosure.

FIG. 5 is a flowchart of a method for providing a semiconductor process simulation according to an embodiment of the present disclosure.

FIGS. 6, 7, 8, 9, 10 and 11 are diagrams illustrating predetermined scenarios related to simulation errors according to an embodiment of the present disclosure.

### DETAILED DESCRIPTION OF EXEMPLARY EMBODIMENTS

Hereinafter, preferred embodiments of the present disclosure will be described in detail with reference to the accompanying drawings. The advantages and features of the present invention and methods for achieving them will become apparent by referring to the embodiments described in detail below together with the accompanying drawings. However, the technical spirit of the present invention is not limited to the embodiments described below and may be implemented in various different forms. The following embodiments are merely provided to fully convey the scope of the technical spirit of the present invention to those of ordinary skill in the art to which the present invention pertains, and the technical spirit of the present invention is defined only by the scope of the claims.

In describing the present disclosure, detailed descriptions of related well-known configurations or functions will be omitted if it is determined that they may obscure the gist of the present invention.

Unless otherwise defined, terms used in the following embodiments (including technical and scientific terms) may be used in a sense commonly understood by those of ordinary skill in the art to which the present invention pertains. However, such terms may vary depending on the intention of the technician, precedent, or the emergence of new technology. The terms used herein are merely for the purpose of describing embodiments and are not intended to limit the scope of the present disclosure.

The singular expressions used in the following embodiments include the plural expressions unless clearly specified otherwise in context. Also, the plural expressions include the singular expressions unless clearly specified otherwise in context.

In addition, the terms first, second, A, B, (a), (b), etc., used in the following embodiments are used to distinguish one component from another, and do not limit the essence, order, or sequence of the components.

Hereinafter, various embodiments of the present disclosure will be described in detail with reference to the accompanying drawings.

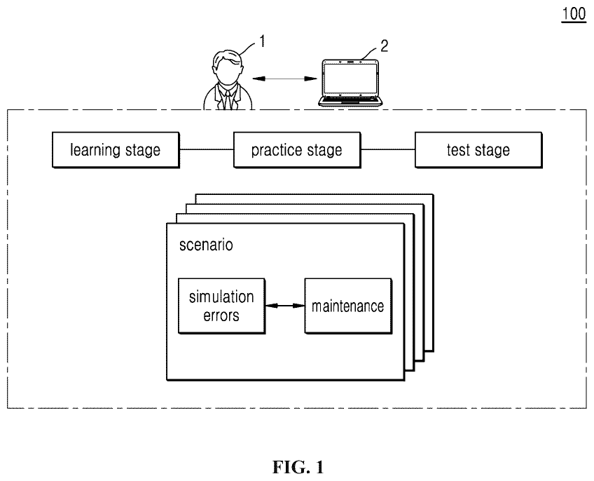

FIG. 1 is a diagram schematically showing a semiconductor process training system according to an embodiment of the present disclosure.

Referring to FIG. 1, in the semiconductor process training system 100, at least one user 1 may perform training on semiconductor processes using an electronic device 2.

In one embodiment, the electronic device 2 may store (or include) a program (or application) for training on semiconductor processes. The electronic device 20 may provide semiconductor process training to the user 1 by executing the program for training on semiconductor processes.

In one embodiment, the electronic device 2 may establish direct or wireless communication with an external server or another device.

For example, the electronic device 2 may communicate with a server providing a program or web-based service (e.g., website, web-based application) for training on semiconductor processes through a wireless communication network. Here, the server may include an application server, computing server, database server, file server, game server, mail server, proxy server, web server, or the like, which perform communication with external devices and process information.

For example, the electronic device 2 may communicate with another device (e.g., a storage medium storing a program for training on semiconductor processes) through a short-range wireless communication network or a direct (e.g., wired) communication channel.

The electronic device 2 may receive a program for training on semiconductor processes from an external server or another device or may be provided with a web-based service. The program for training on semiconductor processes may be stored (or deployed or installed) in the electronic device 2. Hereinafter, it is understood that the electronic device 2 performs the operations described below by executing the program stored in the electronic device 2, through data transmission/reception with the external server (e.g., interaction with a program or website provided by the external server), and/or data transmission/reception with another device.

In one embodiment, the electronic device 2 may provide contents for device learning, process learning, and process practice as semiconductor process training. For example, the program for training on semiconductor processes may include a device learning step, a process learning step, and a process practice step.

Device learning may include learning about the concepts, components, and/or operation principles of various semiconductor devices such as MOSFET (metal-oxide semiconductor field-effect transistor), CMOS (complementary metal-oxide semiconductor), DRAM (dynamic random access memory), RAM (random access memory), or NAND (negative-AND) flash memory.

Semiconductor devices are not limited to the above examples. Device learning may also include learning about the connection, combination, or stacking structure of multiple semiconductor devices.

Device learning may include learning about multiple layers (or structures corresponding to each layer) constituting a single semiconductor device. Through each layer of the semiconductor device, the basic structure forming the semiconductor device may be built, and the “structure” may be understood as a component or functional portion of the semiconductor device.

Process learning may include learning about oxidation, photolithography, etching, deposition, cleaning, metal interconnect, EDS (electrical die sorting), and packaging, which are the eight major manufacturing processes of semiconductors. Specifically, process learning may include learning about ingot production, ingot cutting, wafer polishing, thermal oxidation, photoresist (PR) coating, exposure, development, wet or dry etching, cleaning, ion implantation, PR stripping, and film formation processes such as chemical vapor deposition (CVD), physical vapor deposition (PVD), and/or atomic layer deposition (ALD).

Process learning may include learning about sub-category processes belonging to a single process. Process learning may include learning about step-by-step detailed processes constituting a single process. Process learning may include learning about equipment used in each process. Process learning may include learning about the processes and process sequences necessary for manufacturing each semiconductor device. For example, process learning may include learning about manufacturing steps that serve specific purposes as part of the entire manufacturing process of a semiconductor device, and the aforementioned processes included in each manufacturing step.

Process practice may include selecting processes and/or equipment required for manufacturing a semiconductor device and setting the process order. In one embodiment, the process practice step may include practicing creating a recipe required for manufacturing a semiconductor device. In addition, the process practice step may include providing a 2D and/or 3D simulation of a product generated by performing processes based on the processes selected and arranged by the user and the created recipe. The electronic device 2 may provide process practice contents that allow the user 1 to directly select the processes and/or equipment required for manufacturing various semiconductor devices, set the process order, and create recipes for each process. The electronic device 2 may provide process practice contents through screens described with reference to various drawings in the present disclosure and may generate recipes for one or more processes arranged in sequence based on user inputs received in response to them. The electronic device 2 may provide process practice contents allowing the user 1 to check the simulation of the product generated by performing one or more processes arranged in sequence based on the recipe.

In semiconductor processes, a “recipe” may refer to a document or setting that specifies in detail the procedures and conditions required for manufacturing a semiconductor device or its constituent structures (or modules).

In the context of semiconductor fabrication, the term “recipe” typically denotes a predefined set of process steps and parameters used to control equipment and achieve desired device characteristics.

In one embodiment, in the present disclosure, the recipe for a semiconductor device or its constituent structures may be referred to as a “test dataset.” The test dataset may include elements such as some or all processes required for manufacturing a semiconductor device, the process sequence of those processes, or test data (or user-set data) corresponding to parameters associated with those processes, and each element may be set based on user input. The electronic device 2 may generate (or determine) a test dataset related to a process set including one or more processes required for manufacturing a semiconductor device based on user input.

In one embodiment, the recipe for a specific process may be referred to as a “sub-test dataset.” The sub-test dataset may include test data corresponding to parameters related to a single process. The electronic device 2 may generate (or determine) a sub-test dataset for each process and detailed steps within the process based on user input. Accordingly, the test dataset related to a process set including one or more processes required for manufacturing a semiconductor device (i.e., the test dataset corresponding to the process set) may include sub-test datasets respectively corresponding to one or more processes.

However, in the present disclosure, the recipe (or test dataset or sub-test dataset) is not limited to semiconductor manufacturing processes, and the recipe may also include documents or settings of various conditions for maintaining virtual semiconductor equipment.

In one embodiment, the electronic device 2 may provide the user 1 with learning, practice, and test stages for troubleshooting as part of semiconductor process training. Troubleshooting may refer to identifying and resolving various problems that occur during the production process through semiconductor processes.

The electronic device 2 may provide learning, practice, and test stages for various predetermined scenarios related to simulation errors in semiconductor process simulations as troubleshooting. For example, the program for training on semiconductor processes may include learning, practice, and test stages. The electronic device 2 may provide the user 1 with contents including learning, practice, and test stages for troubleshooting. In one embodiment, the electronic device 2 may provide contents for troubleshooting as part of the above-described process practice.

The learning, practice, and test stages for troubleshooting as part of semiconductor process training may be distinguished according to whether a guide is provided to the user 1 or whether troubleshooting is completed within a limited time. For example, the electronic device 2 may provide the user 1 with guide voices, guide texts, and/or guide images in the learning stage. For example, the electronic device 2 may allow the user 1 to confirm the learning content through an arbitrary scenario in the practice stage. For example, the electronic device 2 may evaluate whether the user 1 completes troubleshooting of a predetermined scenario within a limited time in the test stage.

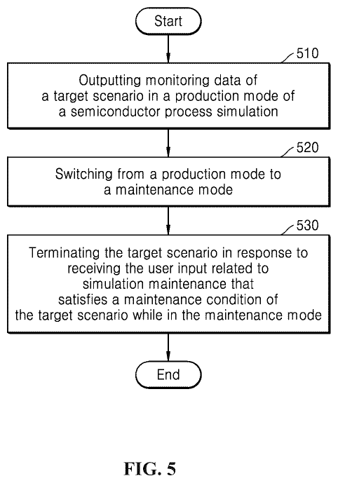

The learning, practice, and test stages of the troubleshooting content may commonly include one or more predetermined scenarios related to simulation errors. The predetermined scenario related to a simulation error may represent a series of maintenance processes required for the user 1 to resolve a problem when a problem occurs with any semiconductor device, semiconductor process (or sub-process), equipment or equipment parts related to semiconductor processes, or a recipe (e.g., test data) based on user input. The electronic device 2 may provide various visual data about the problem situation according to the predetermined scenario related to the simulation error. The electronic device 2 may determine whether to terminate the corresponding scenario according to the predetermined scenario related to the simulation error based on user input received in response to each problem situation. The method of providing troubleshooting content will be described in detail with reference to FIG. 5.

In one embodiment, the system 100 may be a semiconductor process training system based on extended reality (XR) content. In the present disclosure, XR may be used as a generic term for virtual reality (VR), augmented reality (AR), and mixed reality (MR). XR content may be VR content, AR content, MR content, or content composed of two or more combinations thereof.

In one embodiment, the electronic device 2 may provide content for device learning and process learning and/or practice implemented on a virtual space (e.g., a virtual fab) where virtual semiconductor equipment is arranged. The electronic device 2 may move the user within the virtual fab, zoom in/zoom out virtual semiconductor equipment or products, display visual data related to the operation of specific virtual semiconductor equipment, specify areas or lengths of products, or display various views of visual data based on user operation input (e.g., touch on a display or pad, key press, cursor movement, drag, or click).

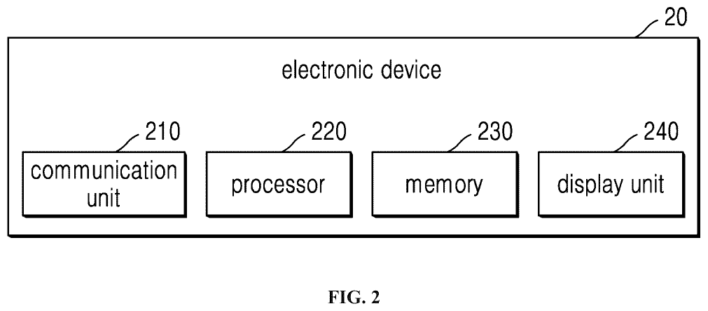

FIG. 2 is a block diagram of an electronic device according to an embodiment of the present disclosure.

In one embodiment, the electronic device 20 may represent the electronic device 2 of FIG. 1. The electronic device 20 may correspond to, for example, a mobile terminal (e.g., smartphone, tablet, laptop, etc.) or a fixed terminal (e.g., personal computer (PC)), but is not limited thereto.

In one embodiment, the electronic device 20 may include a communication unit 210, a processor 220, a memory 230, and a display unit 240.

The communication unit 210 may transmit and receive data while being connected to the processor 220, memory 230, and display unit 240. The communication unit 210 may transmit and receive data while being connected to an external server or another device. Hereinafter, the expression “transmitting and receiving A” may mean transmitting and receiving “information or data representing A.”

The communication unit 210 may be implemented as circuitry within the electronic device 20. For example, the communication unit 210 may include an internal bus and an external bus. In another example, the communication unit 210 may be a component that connects the electronic device 20 to an external server or another device. The communication unit 210 may be an interface. The communication unit 210 may receive data from an external device and transmit the data to the processor 220 and memory 230.

The communication unit 210 may include one or more components that enable communication between the electronic device 20 and an external server or another device, and may include, for example, at least one of a broadcast receiving module, a wired communication module, a wireless communication module, a short-range communication module, and a location information module.

The communication unit 210 may include a wireless communication module that supports various wireless communication methods such as Wi-Fi, WiBro (Wireless Broadband), GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G.

The communication unit 210 may include a wireless communication interface comprising an antenna and a transmitter for transmitting mobile communication signals. Additionally, the wireless communication module may further include a mobile communication signal conversion module for modulating digital control signals output from the control unit into analog wireless signals through the wireless communication interface under the control of the control unit.

The communication unit 210 may include a wireless communication interface comprising an antenna and a receiver for receiving mobile communication signals. Additionally, the wireless communication module may further include a mobile communication signal conversion module for demodulating analog wireless signals received through the wireless communication interface into digital control signals.

The processor 220 may process data received by the communication unit 210 and data stored in the memory 230. The “processor” may be a data processing device implemented as hardware having a circuit with a physical structure for executing desired operations. For example, the desired operations may include codes or instructions included in a program. The hardware-implemented data processing device may include a microprocessor, central processing unit (CPU), processor core, multi-core processor, multiprocessor, application-specific integrated circuit (ASIC), or field-programmable gate array (FPGA).

The memory 230 may store at least one instruction. The memory 230 may store a set of instructions (e.g., software) for operating the electronic device 20. The set of instructions for operating the electronic device 20 may be executed by the processor 220.

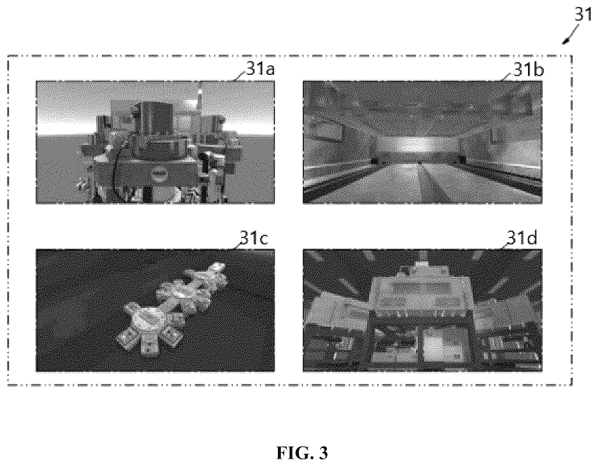

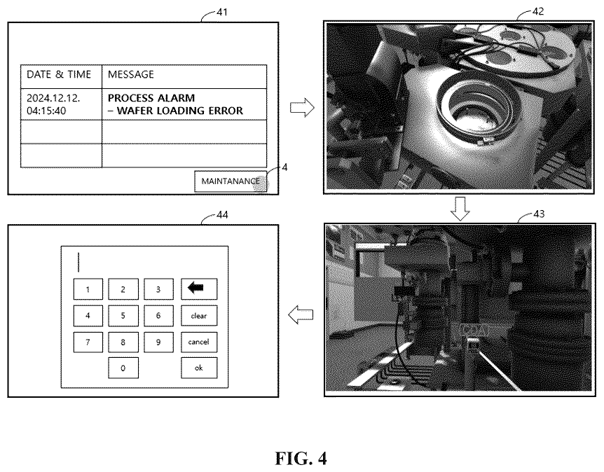

In one embodiment, the memory 230 may store virtual visual data. The visual data may include visual data related to content for device learning and process learning and/or content for practice provided through the display unit 240. The visual data will be described in detail with reference to FIGS. 3 and 4.

In one embodiment, the memory 230 may store predefined reference datasets for at least one of the processes required for manufacturing a semiconductor device, the process order of the respective processes, parameters related to the respective processes, or pattern setting data of a structure formed by performing at least one process included in any manufacturing step. The memory 230 may store various semiconductor devices, manufacturing steps of semiconductor devices, and/or processes. The descriptions of semiconductor devices, manufacturing steps, and processes may be omitted as they are redundant with the descriptions given with reference to FIG. 1. The memory 230 may store parameters related to one or more processes required for manufacturing each of the various semiconductor devices. The parameters may be defined in each process. The parameters may include parameters related to the processing conditions of a process (e.g., type of fluid, amount of fluid, temperature, density, pressure, composition ratio of substances, RF power, process time, vacuum state). The parameters may also include parameters related to the operating conditions of a virtual device performing the process (e.g., scrubber, pump, pure chemical water (PCW)).

For example, the reference dataset may include evaluation reference data ranging from the optimal process order (or manufacturing step order) of one or more processes included in the manufacturing steps of a semiconductor device to preferred, relatively inappropriate, or incorrect process orders. For example, the memory 230 may store weights corresponding to respective cases of the manufacturing steps and manufacturing step orders of a semiconductor device as evaluation reference data. The memory 230 may also store weights corresponding to respective cases of one or more processes and process orders included in any manufacturing step as evaluation reference data.

For example, the reference dataset may include predefined evaluation reference data for each candidate process associated with any process among one or more processes included in an arbitrary manufacturing step. The reference dataset may include evaluation reference data ranging from the optimal candidate process (or process type) associated with any process among one or more processes included in an arbitrary manufacturing step to preferred, relatively inappropriate, or incorrect candidate processes. For example, the memory 230 may store weights corresponding to candidate processes associated with any process included in a specific manufacturing step and to each of the candidate processes as evaluation reference data.

For example, the reference dataset may include predefined evaluation reference data for pattern setting data of a structure formed by performing at least one process included in an arbitrary manufacturing step. For example, the memory 230 may store weights corresponding to pattern setting data (e.g., shape, position, length, or width) of a structure formed by performing at least one process included in a specific manufacturing step as evaluation reference data.

For example, the reference dataset may include predefined sub-reference datasets for each process required for manufacturing a semiconductor device. The sub-reference dataset may include predefined evaluation reference data for each parameter associated with a process. The sub-reference dataset may include evaluation reference data ranging from optimal specifications for parameters associated with an arbitrary process to preferred, relatively inappropriate, or incorrect specifications. For example, the memory 230 may store one or more specifications corresponding to each parameter related to a specific process and weights corresponding to each of the one or more specifications as evaluation reference data.

In one embodiment, the reference dataset may include information on the characteristics of the product. For example, the reference dataset may include all possible cases of manufacturing step orders of manufacturing steps of a semiconductor device and information on the characteristics of the product mapped to each case. For example, the reference dataset may include all possible cases of process orders of one or more processes included in an arbitrary manufacturing step and information on the characteristics of the product mapped to each case. In this case, the characteristics of the product generated by an arbitrary manufacturing step (or process) may reflect the characteristics of the product (or structure or intermediate result) generated by the previous manufacturing step (or process) and mapped to the corresponding manufacturing step.

For example, the reference dataset may include all possible combinations of candidate processes corresponding to at least some of one or more processes included in an arbitrary manufacturing step and information on the characteristics of the product (or structure or intermediate result) mapped to each combination.

For example, the reference dataset may include all possible cases or combinations of pattern setting data of a structure formed by performing at least one process included in an arbitrary manufacturing step and information on the characteristics of the product (or structure or intermediate result) mapped to each case or combination.

For example, the reference dataset may include information on the characteristics of the product (or structure or intermediate result) generated by a combination of specifications corresponding to respective parameters related to semiconductor processes. For example, the sub-reference dataset may include all possible combinations of specifications corresponding to parameters (P11, P12, P13, P14) associated with any process and information on the characteristics of the product mapped to each combination.

In one embodiment, the reference dataset may be stored in the memory 230 in the form of a lookup table. The sub-reference dataset may also be stored in the memory 230 in the form of a lookup table.

In one embodiment, the memory 230 may store a predefined target dataset including at least one of optimal processes required for manufacturing a semiconductor device, the optimal process order of the respective processes, the optimal specifications of parameters related to the respective processes, or optimal pattern setting data of the structures to be formed. That is, the target dataset may include at least one of processes, process orders, recipes for the respective processes, or pattern setting data of structures corresponding to the “correct answer” for manufacturing a specific semiconductor device.

For example, the target dataset may include information on manufacturing steps corresponding to the “correct answer” for a specific semiconductor device and the manufacturing step order. For example, the target dataset may include information on one or more processes corresponding to the “correct answer” and the process order included in a specific manufacturing step.

For example, the target dataset may include information on candidate processes corresponding to any process among one or more processes included in a specific manufacturing step and corresponding to the “correct answer.”

For example, the target dataset may include information on pattern setting data corresponding to the “correct answer” for a structure formed by performing at least one process included in a specific manufacturing step.

For example, the target dataset may include a sub-target dataset including the optimal specifications of parameters related to any process. That is, the sub-target dataset may be a recipe corresponding to the “correct answer” for a process.

The memory 230 may store target evaluation data of an optimal product generated by performing one or more processes according to the target dataset. Here, “performing processes according to the target dataset” may include “performing processes according to one or more sub-target datasets,” and the optimal product generated by performing processes according to the target dataset may represent the optimal structure or intermediate result of a semiconductor device or a completed semiconductor device.

The memory 230 may store data supporting various functions of the electronic device 20, programs for the operation of the processor 220, and input/output data (e.g., music files, still images, videos, etc.), and may store multiple applications (application programs or applications) driven by the electronic device 20, data for operating the electronic device 20, and instructions. At least some of these applications may be downloaded from an external server via wireless communication.

The memory 230 may include at least one type of storage medium, such as a flash memory type, hard disk type, solid-state disk (SSD) type, silicon disk drive (SDD) type, multimedia card micro type, card-type memory (e.g., SD or XD memory, etc.), random access memory (RAM), static random access memory (SRAM), read-only memory (ROM), electrically erasable programmable read-only memory (EEPROM), programmable read-only memory (PROM), magnetic memory, magnetic disk, or optical disk. Additionally, the memory 230 may be a database that is separate from the system but connected by wire or wirelessly.

The processor 220 may communicate with the memory 230 and execute at least one instruction stored in the memory 230. When the instructions stored in the memory 230 are executed individually or collectively by at least one processor 220, the electronic device 20 may perform at least some of the operations described in the present disclosure.

The control unit of the electronic device 20 may be implemented as a memory 230 for storing data of an algorithm or a program reproducing the algorithm for controlling the operations of components within the electronic device 20 and at least one processor 220 that performs communication with the memory 230 and performs the above-described operations using the data stored in the memory 230. In this case, the memory 230 and the processor 220 may be implemented as separate chips, or the memory 230 and the processor 220 may also be implemented as a single chip.

The processor 220 may also control any one or more combinations of the above-described components to implement various embodiments of the present disclosure described in FIGS. 3 to 11 on the electronic device 20.

The display unit 240 may display (output) information processed by the electronic device 20 and visual data stored in the memory 230. For example, the display unit 240 may display execution screen information of an application driven by the electronic device 20 or UI (User Interface) or GUI (Graphic User Interface) information according to the execution screen information.

The electronic device 20 may include a user input unit for receiving information from a user. The processor 220 may control the operation of the electronic device 20 according to the information input through the user input unit. In one embodiment, the user input unit may include hardware physical keys (e.g., buttons located on at least one of the front, back, or side surfaces of the electronic device 20, dome switches, jog wheels, or jog switches, or keyboard keys) and/or software touch keys. For example, the touch key may be composed of virtual keys, soft keys, or visual keys displayed on a touchscreen-type display unit 240 through software processing or touch keys disposed on parts other than the touchscreen. The virtual key or visual key may have various shapes and may be displayed on the touchscreen, and may be composed of, for example, graphics, text, icons, videos, or combinations thereof.

At least one component of the electronic device 20 shown in FIG. 2 may be added or deleted according to the performance of the components. Also, the relative positions of the components may be changed according to the performance or structure of the system, which will be easily understood by those of ordinary skill in the art.

Meanwhile, each of the components shown in FIG. 2 refers to hardware components such as software, an FPGA (Field Programmable Gate Array), or an application-specific integrated circuit (ASIC).

FIG. 3 illustrates visual data according to various examples of the present disclosure.

FIG. 3 shows screens and/or visual data according to various examples displayed through a display (e.g., the display unit 240 of FIG. 2) of an electronic device (e.g., the electronic device 2 of FIG. 1 or the electronic device 20 of FIG. 2). According to one embodiment, the electronic device may display visual data to the user in real-time through the display. According to one embodiment, the electronic device may be a server or a computer that transmits visual data to an external device (e.g., an XR device such as a head-mount display (HMD)) via a communication module (e.g., the communication unit 210 of FIG. 2). The external electronic device may receive visual data from the electronic device, and the visual data may be displayed through the display of the external electronic device. Hereinafter, depending on the embodiment, the expression that the electronic device displays a screen (or visual data) includes not only the case where the electronic device displays the screen itself but also the case where the external electronic device, which receives the visual data to be displayed on the screen from the electronic device, displays the screen.

The content for process learning and/or process practice may include information on equipment used for each process. The content may include visual data 31 shown in FIG. 3. The electronic device may display an explanation of the equipment based on the user's operation input for the visual data 31. For example, the electronic device may display information such as the function, operation sequence, and operation principle of specific equipment or parts displayed in visual data 31a based on the user's operation input, such as selecting the specific equipment or parts or hovering a cursor.

The visual data 31 of FIG. 3 shows virtual semiconductor equipment arranged in a virtual space (e.g., a virtual fab). For example, the visual data 31a may represent multiple auxiliary parts arranged outside the virtual semiconductor equipment. According to the display mode change by the user (e.g., a selection input for an interface element displayed on the screen), the electronic device may display visual data 31b allowing the user to check the inside of the virtual semiconductor equipment in a first mode, visual data 31c allowing the user to check all virtual semiconductor equipment arranged in the virtual fab in a second mode, or visual data 31d allowing the user to check the virtual semiconductor equipment in actual size in a third mode.

Specifically, the visual data 31b of the first mode may be most suitable for the user to learn key processes conducted inside the virtual semiconductor equipment. The visual data 31c of the second mode may be most suitable for the user to learn where the process currently being studied is located within the entire process and the progress of multiple processes being conducted simultaneously. Furthermore, the visual data 31d of the third mode may be most suitable for the user to learn the shape or arrangement of the equipment used in the actual semiconductor process and the engineer's movement path during the actual semiconductor process.

Accordingly, by selecting the most suitable mode for each process, the user can efficiently conduct process learning and effectively improve their achievement. Additionally, by selecting a mode according to the user's needs, the user's learning interest and participation can be increased.

The content for process learning and/or process practice may include the processes required to manufacture each semiconductor device and the order of such processes. For example, the content for process learning and/or process practice may include manufacturing steps, each having a specific objective as part of the overall manufacturing process of a semiconductor device, and the aforementioned processes included in each manufacturing step.

In one embodiment, the manufacturing process of a semiconductor device such as a MOSFET may include the following manufacturing steps: active region formation, well formation (e.g., p-well or n-well), threshold voltage (Vth) adjustment, gate formation, lightly doped drain (LDD) formation (e.g., PLDD or NLDD), source/drain formation, spacer formation, contact hole (or contact via) formation, and metal interconnect formation.

For example, the manufacturing step for active region formation may include oxidation, CVD, photolithography, etching, and CMP processes. More specifically, the process sequence may include dry oxidation, CVD, HMDS treatment, photoresist (PR) coating, soft bake, exposure, post-exposure bake, development, hard bake, etching, PR strip, etching, CVD, etching, and CMP.

FIG. 4 is a diagram illustrating visual data according to various examples of the present disclosure. FIG. 4 illustrates screens and/or visual data displayed on the display (e.g., the display unit 240 of the electronic device 20) of an electronic device (e.g., the electronic device 2 of FIG. 1 or the electronic device 20 of FIG. 2) according to various examples.

In one embodiment, the electronic device may display visual data to the user in real time via the display. In another embodiment, the electronic device may operate as a server device or computer and transmit visual data to an external electronic device (e.g., an XR device such as a head-mounted display (HMD)) which communicates with the electronic device via a communication module (e.g., the communication unit 210 of FIG. 2). The external electronic device may receive the visual data from the electronic device and display it through its own display. Accordingly, depending on the embodiment, the expression that the electronic device displays the screen (or visual data) may include both the case where the electronic device directly displays the screen and the case where the external electronic device displays the screen using visual data received from the electronic device.

The content for troubleshooting may include details of one or more predefined scenarios related to simulation errors. This content may include the visual data 41-44 shown in FIG. 4.

In a production mode of a semiconductor process simulation, the electronic device may display visual data representing the internal and external status of virtual semiconductor equipment placed in a virtual space (e.g., a virtual fab), as described with reference to FIG. 3.

In one embodiment, in the production mode of the semiconductor process simulation, the electronic device may output monitoring data of a target scenario among one or more predefined scenarios related to simulation errors of the semiconductor process simulation. The monitoring data of the target scenario may include visual data associated with the predefined simulation error information of the target scenario. The monitoring data of the target scenario may represent log data of the semiconductor process simulation. For example, as shown in visual data 41, the electronic device may display text data indicating simulation error information (e.g., wafer loading error) of the target scenario on a monitor of the semiconductor process.

In one embodiment, the electronic device may switch from the production mode to a maintenance mode based on user input for mode switching (e.g., selection of a “Maintenance” button 4).

In the maintenance mode of the semiconductor process simulation, the electronic device may display various visual data based on user input. For example, based on user input selecting buttons or pop-ups for “All Gas Purge,” “Gas Evacuation,” “Ventilation,” and “Chamber Open,” the electronic device may display visual data (e.g., image data 42) indicating the processes of purging all hazardous gases from the chamber, evacuating any remaining gases, ventilating the chamber with air to match atmospheric pressure, and opening the chamber lid. The electronic device may also display image data showing wafer disposal based on user input selecting a button or pop-up for “Wafer Disposal.”

For example, the electronic device may display visual data 43 for receiving user input regarding simulation maintenance based on user operation (or selection) input to interface elements displayed on the screen, such as selecting a specific piece of equipment or component or hovering a cursor over it. The electronic device may display image data showing the component for adjusting test data corresponding to a simulation parameter (e.g., CDA (clean dry air) pressure). The electronic device may also display visual data 44 representing an interface element for receiving the adjusted test data.

In addition to the visual data 41-44 described with reference to FIG. 4, the visual data for troubleshooting content may include interface elements for switching between production mode and maintenance mode (e.g., “Maintenance” button, “Production” button).

The visual data for troubleshooting content may include interface elements for receiving user input related to maintenance. For example, interface elements for receiving user input related to maintenance may include elements for adjusting test data corresponding to parameters related to the semiconductor process simulation (e.g., input elements for the value or value range of test data like visual data 44), user-selectable items for replacing or adjusting parts of virtual equipment related to the semiconductor process simulation (e.g., susceptor replacement, gas valve replacement, O-ring replacement, cable replacement, TMP replacement, communication module reset, initialization, adjustment of mounted state, etc.), and/or user-selectable items for user actions related to the semiconductor process simulation (e.g., part removal, part reassembly, power supply, wafer disposal, reporting to the control system, gas injection, particle or contamination removal, etc.).

FIG. 5 is a flowchart illustrating a method of providing semiconductor process simulation according to an embodiment of the present disclosure.

According to one embodiment, the operations 510 to 530 below may be performed by an electronic device (e.g., the electronic device 2 of FIG. 1 or the electronic device 20 of FIG. 2). The electronic device may include at least some of the components of the electronic device 20 described above with reference to FIG. 2. For example, the electronic device may include a communication unit (e.g., the communication unit 210 of FIG. 2), a processor (e.g., the processor 220 of FIG. 2), a memory (e.g., the memory 230 of FIG. 2), and a display unit (e.g., the display unit 240 of FIG. 2).

According to one embodiment, the electronic device may provide troubleshooting content as semiconductor process training. As described with reference to FIG. 1, the troubleshooting content may include one or more predetermined scenarios related to simulation errors.

The electronic device may store one or more predetermined scenarios related to simulation errors. Each of the one or more predetermined scenarios may include predefined simulation error information and maintenance information corresponding to the simulation error information.

In one embodiment, the simulation error information may represent a problem that has occurred in an arbitrary semiconductor device, a semiconductor process (or sub-process), equipment or a component of equipment related to the semiconductor process, and/or a recipe (e.g., test data) based on user input.

For example, the simulation error information may include various problems such as wafer loading error in a plasma enhanced chemical vapor deposition (PECVD) process, chamber pressure abnormality in a PECVD process, turbo molecular pump (TMP) malfunction in a physical vapor deposition (PVD) process, plasma generation error in a PVD process, poor etch rate in an etching process, or gas leakage in an etching process chamber. These are merely examples, and the simulation error information is not limited to the above.

In one embodiment, the maintenance information corresponding to the simulation error information may include test data information corresponding to parameters related to the semiconductor process simulation. The test data information corresponding to parameters related to the semiconductor process simulation may represent specifications (e.g., values or value ranges) set so that a semiconductor process can be appropriately simulated for an arbitrary parameter (e.g., fluid amount, temperature, pressure, process time, etc.).

In one embodiment, the maintenance information corresponding to the simulation error information may include virtual equipment component replacement information related to the semiconductor process simulation. The component replacement information related to virtual equipment may indicate user-selectable items to replace components of the virtual equipment—such as a susceptor, gas valve, O-ring, cable, or turbo molecular pump (TMP)—when the corresponding issue results from a hardware-related cause (e.g., aging or failure).

In one embodiment, the maintenance information corresponding to the simulation error information may include virtual equipment component adjustment information related to the semiconductor process simulation. The component adjustment information may indicate user-selectable items for resetting or initializing components of the virtual equipment or adjusting their mounting conditions.

In one embodiment, the maintenance information corresponding to the simulation error information may include user action information related to the semiconductor process simulation. The user action information may represent user-selectable items such as discarding a wafer due to simulation interruption, injecting gas, opening or closing a gas valve, removing particles or contamination inside the virtual equipment, disassembling and reassembling components, or supplying power to the virtual equipment. The user action information may include not only actions for resolving the simulation error but also actions for identifying the problem situation.

In operation 510, the electronic device may output monitoring data of a target scenario, among one or more preset scenarios related to simulation errors, in the production mode of the semiconductor process simulation based on user-input test data. The monitoring data of the target scenario may include visual data related to preset simulation error information of the target scenario. The monitoring data of the target scenario may represent log data of the semiconductor process simulation. The visual data related to the preset simulation error information of the target scenario may include numerical data, image data, or text data representing the preset simulation error information.

In operation 520, the electronic device may switch from the production mode of the semiconductor process simulation to a maintenance mode. In one embodiment, the electronic device may switch from the production mode to the maintenance mode based on receiving a user input for switching to the maintenance mode.

In operation 530, in the maintenance mode, if the user input related to simulation maintenance satisfies the maintenance condition of the target scenario, the electronic device may terminate the target scenario. The electronic device may terminate the target scenario when the user input related to simulation maintenance corresponds to the maintenance information of the target scenario. In one embodiment, if the target scenario includes multiple simulation error information-maintenance information pairs, the electronic device may terminate the target scenario upon receiving user inputs corresponding to all maintenance information of the target scenario.

After terminating the target scenario, the electronic device may switch back to the production mode of the semiconductor process simulation. In the production mode, the electronic device may output visual data indicating normal operation of the semiconductor process simulation. For example, the electronic device may output visual data indicating the normal state of the internal or external parts of the virtual equipment used in the semiconductor process simulation (e.g., replaced or adjusted components, process flow, or product).

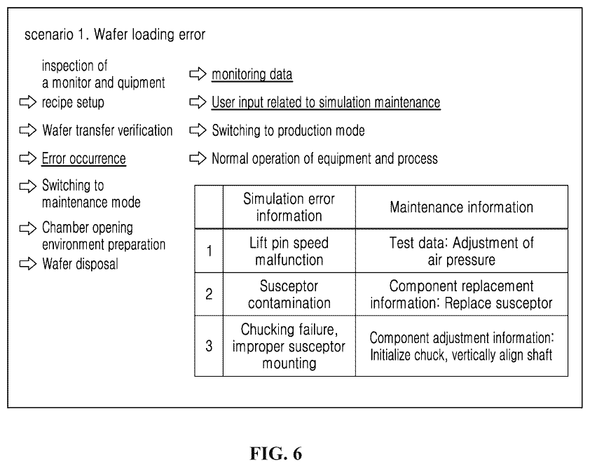

FIGS. 6 through 11 are diagrams illustrating preset scenarios related to simulation errors according to an embodiment of the present disclosure. An electronic device (e.g., the electronic device 2 of FIG. 1 or the electronic device 20 of FIG. 2) may store different preset scenarios related to simulation errors as shown in FIGS. 6 through 11.

In the scenarios illustrated in FIGS. 6 through 11, the electronic device may output visual data representing the monitor and virtual equipment of a semiconductor process corresponding to each scenario. The monitor may represent a graphical element that allows the user to check the monitoring data (or the log data of the semiconductor process simulation) of each scenario.

In the scenarios of FIGS. 6 through 11, the electronic device may determine a test dataset (or recipe) for each scenario based on user input. The test dataset may include data elements set based on the user input. In one embodiment, the test dataset may include the manufacturing steps of a semiconductor device and the sequence of those steps. In another embodiment, the test dataset may include one or more processes (or a process set) and the process order. In another embodiment, the test dataset may include test data corresponding to each parameter related to an arbitrary process (e.g., specifications of values or value ranges selected or input by the user).

Based on the user-input test dataset (e.g., test data), the electronic device may output visual data related to the semiconductor process simulation in the production mode. For example, as described with reference to FIG. 3, the electronic device may output visual data representing components disposed on the outside of virtual equipment related to the semiconductor process simulation and/or visual data allowing the interior of the virtual equipment to be observed. For instance, the electronic device may output visual data showing the movement of a product (e.g., wafer) as the semiconductor process simulation proceeds.

In the production mode of the semiconductor process simulation based on user-input test data, the electronic device may output monitoring data of a target scenario among one or more preset scenarios related to simulation errors. The monitoring data of the target scenario may include visual data related to preset simulation error information of the target scenario. The monitoring data of the target scenario may represent log data of the semiconductor process simulation. The visual data related to the preset simulation error information of the target scenario may include numerical data, image data, or text data representing the preset simulation error information.

Referring to FIG. 6, the target scenario may be a scenario related to a “wafer loading error.” For example, the electronic device may output visual data (e.g., text data or image data) indicating that a “wafer loading error” has occurred during the PECVD process. Based on a user input for switching to maintenance mode (e.g., selection of a “maintenance” button), the electronic device may transition from production mode to maintenance mode.

Based on a user input selecting buttons or popups for “all gas purge,” “gas evacuation,” “ventilation,” “chamber open,” and “wafer disposal,” the electronic device may sequentially output image data showing the purging of all harmful gases from the chamber, the evacuation of any remaining gases, the ventilation of air into the chamber to equalize the pressure with atmospheric pressure, the opening of the chamber lid, and the disposal of the wafer.

The preset simulation error information of the “wafer loading error” scenario may include at least one of the following: lift pin malfunction (e.g., slow or irregular speed), susceptor contamination, chucking failure, or improper susceptor mounting.

The maintenance information corresponding to the lift pin speed malfunction may include test data specifications (e.g., a value or range) related to adjustment of CDA (clean dry air) pressure as a parameter associated with the semiconductor process simulation. The maintenance information corresponding to susceptor contamination may include a user-selectable option for susceptor replacement as virtual equipment part replacement information. The maintenance information corresponding to chucking failure may include a user-selectable option for chuck initialization as virtual equipment part adjustment information. The maintenance information corresponding to improper susceptor mounting may include a user-selectable option for vertical shaft alignment as virtual equipment part adjustment information.

In one embodiment, the electronic device may output image data indicating a lift pin speed malfunction as monitoring data for the “wafer loading error” scenario. For example, upon receiving a user input selecting the “pin movement” button, the electronic device may output image data showing the lift pin rapidly moving up and down. As a user input for simulation maintenance, the electronic device may receive a user input that adjusts test data corresponding to the parameter CDA pressure in the simulation (e.g., adjusting the CDA gauge value to 20), which corresponds to the relevant maintenance information.

In one embodiment, the electronic device may output image data indicating susceptor contamination as monitoring data for the “wafer loading error.” For example, the electronic device may display image data showing the condition of the susceptor inside the chamber. As a user input for simulation maintenance, the electronic device may receive an input corresponding to susceptor replacement (i.e., a user input corresponding to the maintenance information).

In another embodiment, the electronic device may output image data indicating chucking failure (e.g., the chuck is tilted) as monitoring data for the “wafer loading error.” As a user input for simulation maintenance, the electronic device may receive an input corresponding to chuck initialization (i.e., a user input corresponding to the maintenance information).

In another embodiment, the electronic device may output image data indicating susceptor mounting failure (e.g., the susceptor is tilted to one side) as monitoring data for the “wafer loading error.” As a user input for simulation maintenance, the electronic device may receive an input corresponding to vertical alignment of the susceptor shaft (i.e., a user input corresponding to the maintenance information).

The electronic device may include at least some of the above-described simulation error information and corresponding maintenance information (or simulation error information-maintenance information pairs) in the target scenario. If the user input for simulation maintenance corresponds to the maintenance information of the target scenario (“wafer loading error”), the electronic device may terminate the target scenario. In one embodiment, if the target scenario includes multiple simulation error information-maintenance information pairs, the electronic device may terminate the target scenario upon receiving all user inputs corresponding to the maintenance information of the target scenario.

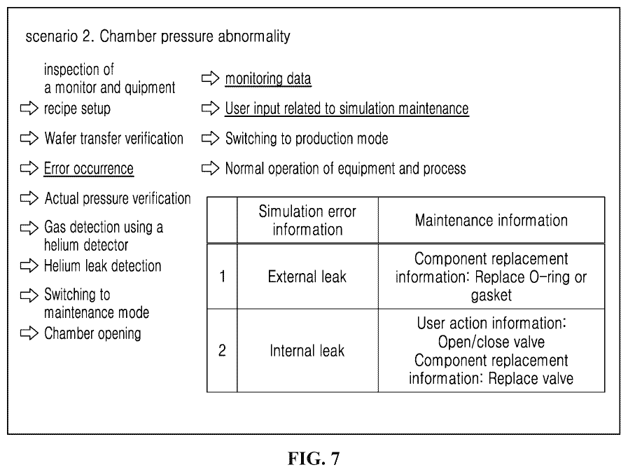

Referring to FIG. 7, the target scenario may be a scenario related to “chamber pressure abnormality.” For example, the electronic device may output visual data (e.g., text data or image data) indicating that a “chamber pressure abnormality” has occurred during the PECVD process. Based on a user input for switching to maintenance mode, the electronic device may transition from production mode to maintenance mode.

In one embodiment, the electronic device may output numerical data indicating that the “actual pressure” exceeds 170 torr. Based on a user input (e.g., pressing a button on the controller) for selecting a “helium detector” and detecting gas near the chamber, the electronic device may output numerical data representing the helium detection value. The user may confirm a helium leak through the numerical data. Based on a user input for switching to maintenance mode (e.g., selecting a “maintenance” button), the electronic device may transition from production mode to maintenance mode.

The preset simulation error information for the “chamber pressure abnormality” scenario may include at least one of an external gas leak or an internal gas leak.

The maintenance information corresponding to an external gas leak may include a user-selectable option to replace a component, such as an O-ring or gasket, in the virtual equipment related to the semiconductor process simulation. The maintenance information corresponding to an internal gas leak may include a user-selectable option related to user actions such as opening and closing valves, and a user-selectable option to replace the faulty valve in the virtual equipment related to the semiconductor process simulation.

In one embodiment, the electronic device may output numerical and/or image data indicating an external gas leak as monitoring data for the “chamber pressure abnormality.” For example, based on a user input for selecting the “helium detector” and detecting gas near the chamber, the electronic device may output numerical data representing the helium detection value. Additionally, the electronic device may output visual data showing the condition of components (e.g., an O-ring or gasket) as monitoring data for the “chamber pressure abnormality.” The electronic device may receive a user input to replace a component (e.g., an O-ring or gasket) as a user input for simulation maintenance (i.e., an input corresponding to the maintenance information).

In one embodiment, the electronic device may output numerical and/or image data indicating an internal gas leak as monitoring data for the “chamber pressure abnormality.” For example, based on a user input that sets the value of the MFC (mass flow controller) to zero and toggles the nitrogen, silane, and ammonia valves, the electronic device may output numerical data indicating a pressure value resulting from the gas leak. The electronic device may receive a user input to replace the faulty valve as a user input for simulation maintenance (i.e., an input corresponding to the maintenance information).

The electronic device may include at least some of the above simulation error information and corresponding maintenance information (i.e., simulation error information-maintenance information pairs) in the target scenario. If the user input for simulation maintenance corresponds to the maintenance information of the target scenario (“chamber pressure abnormality”), the electronic device may terminate the target scenario. In one embodiment, when the target scenario includes multiple simulation error information-maintenance information pairs, the electronic device may terminate the target scenario if it receives user inputs corresponding to all the maintenance information of the target scenario.

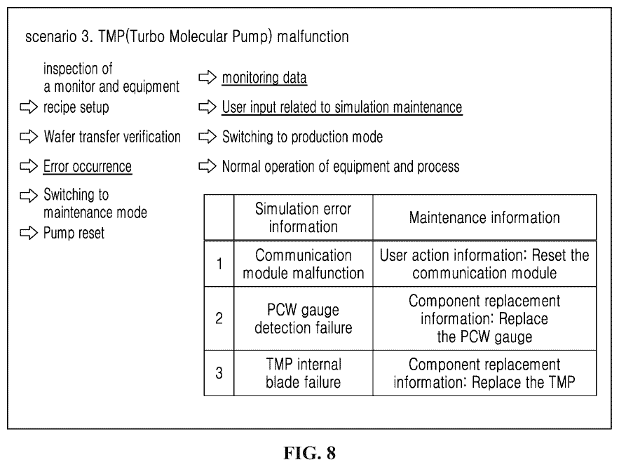

Referring to FIG. 8, the target scenario may be related to a “turbo molecular pump (TMP) malfunction.” For example, the electronic device may output visual data (e.g., text or image data) indicating that a TMP malfunction has occurred during the PVD process. Based on a user input for switching to maintenance mode (e.g., selecting a “maintenance” button), the electronic device may transition from production mode to maintenance mode.

In one embodiment, the electronic device may, based on a user input selecting a “pump reset” button, output image data showing the TMP RPM gauge on the monitor indicating a value of zero instead of the normal RPM (e.g., 45,000).

The preconfigured simulation error information for the “turbo molecular pump (TMP) malfunction” scenario may include at least one of a communication module failure, PCW (pure chemical water) gauge detection failure, or a defect in the internal blades of the TMP.

The maintenance information corresponding to the communication module failure may include a user-selectable item corresponding to a communication module reset, as part of user action information related to the semiconductor process simulation. The maintenance information corresponding to the PCW gauge detection failure may include a user-selectable item for replacing the PCW gauge, as part of the virtual equipment component replacement information. The maintenance information corresponding to the TMP blade defect may include a user-selectable item for replacing the TMP.

In one embodiment, the electronic device may output numerical and/or image data indicating a communication module failure (e.g., discrepancy between the TMP RPM value displayed on the monitor and the actual TMP RPM) as monitoring data for the “TMP malfunction.” The electronic device may receive a user input to reset the communication module as a user input for simulation maintenance (i.e., an input corresponding to the maintenance information).

In one embodiment, the electronic device may output image data indicating a PCW gauge detection failure as part of the monitoring data for the “TMP malfunction.” For example, this may include a red light being displayed instead of the normal green light on the PCW gauge, or the PCW gauge value being shown as zero. The electronic device may receive a user input to replace the PCW gauge as maintenance input (i.e., an input corresponding to the maintenance information).

In another embodiment, the electronic device may output image data indicating a defect in the internal blades of the TMP—such as abnormal noise or vibration near the TMP equipment—as part of the monitoring data for the “TMP malfunction.” The electronic device may receive a user input to replace the TMP as maintenance input (i.e., an input corresponding to the maintenance information).

The electronic device may include at least some of the above-described simulation error information and the corresponding maintenance information (or error-maintenance pairs) in the target scenario. If the user input related to simulation maintenance corresponds to the maintenance information of the target scenario (“TMP malfunction”), the electronic device may terminate the target scenario. In one embodiment, if the target scenario includes multiple error-maintenance pairs, the electronic device may terminate the scenario when it has received user inputs corresponding to all required maintenance actions.

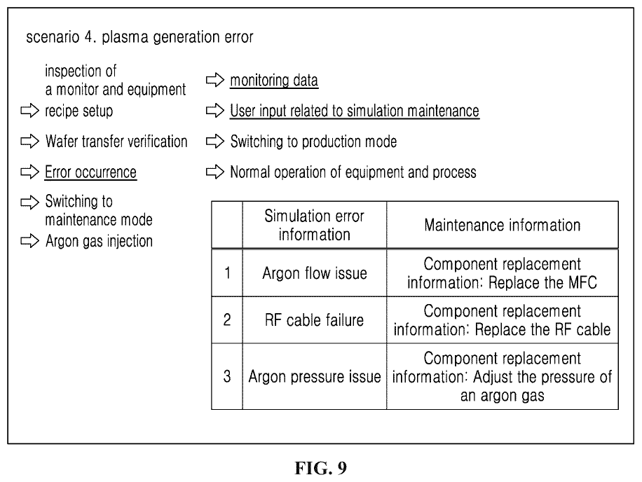

Referring to FIG. 9, the target scenario may be one related to a “plasma generation error.” For example, the electronic device may output visual data (e.g., text or image data) indicating that a plasma generation error has occurred in the PVD process. The device may switch from the production mode to the maintenance mode based on a user input (e.g., selecting a “maintenance” button).

In one embodiment, the electronic device may receive a series of user inputs—such as selecting “Ar flow” and entering a value (e.g., 500 sccm), selecting “Ar injection” (e.g., Ar-Bypass button), and selecting the “Operate” button—and, based on these inputs, sequentially output image data showing that argon gas is injected but plasma is not generated.

The preconfigured simulation error information for the “plasma generation error” scenario may include at least one of: an issue with argon flow, a faulty RF cable, or a drop in argon pressure.

The maintenance information corresponding to an argon flow issue may include a user-selectable option to replace the MFC, as part of component replacement information in relation to the semiconductor process simulation. For an RF cable failure, the corresponding maintenance information may include a user option to replace the RF cable. For a drop in argon pressure, the maintenance information may include test data specifications related to pressure adjustment—i.e., a value or acceptable range corresponding to the pressure parameter.

In one embodiment, the electronic device may output image data representing the argon flow issue as part of the monitoring data for the “plasma generation error.” For example, based on receiving a sequence of user inputs—selecting “Ar flow,” inputting a value, selecting “Ar injection,” and selecting the “Operate” button—the electronic device may output image data showing that plasma is not being generated. The device may receive a user input to replace the MFC as maintenance input (i.e., input corresponding to the maintenance information).

In one embodiment, the electronic device may output image data representing an RF cable failure as part of the monitoring data for the “plasma generation error.” For example, after the user selects the “RF generator on” button, the device may display image data indicating that plasma is not generated. The electronic device may then receive a user input for replacing the RF cable and initializing the hardware—inputs corresponding to the maintenance information.

In another embodiment, the electronic device may output numerical and/or image data representing an argon pressure issue as part of the monitoring data. For example, the device may display data showing that the argon pressure is abnormally high or low. The electronic device may receive a user input for adjusting the argon pressure, which corresponds to the specified maintenance information.

The electronic device may include at least part of the above-described simulation error information and its corresponding maintenance information (i.e., simulation error-maintenance information pairs) within the target scenario. If the user inputs for simulation maintenance correspond to the maintenance information for the target scenario (“plasma generation error”), the device may terminate the scenario.

In one example, if the target scenario includes multiple simulation error-maintenance information pairs, the electronic device may terminate the target scenario only after receiving user inputs corresponding to all required maintenance actions.

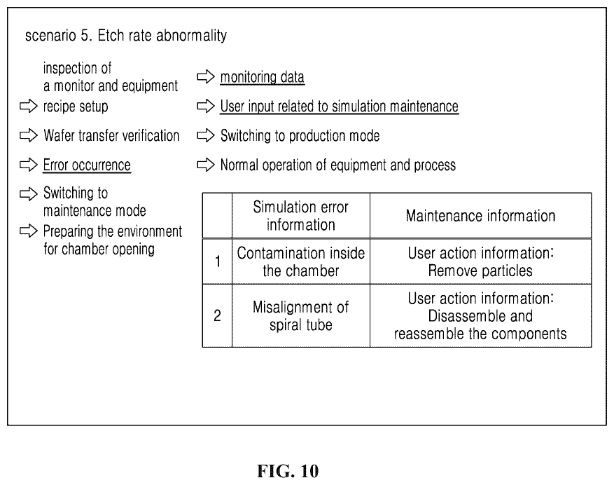

In one embodiment, referring to FIG. 10, the target scenario may correspond to an “etch rate abnormality.” For example, the electronic device may output visual data (e.g., text or image data) indicating that an etch rate failure has occurred during the etching process. The device may switch from production mode to maintenance mode based on user input (e.g., selection of a “maintenance” button).

The electronic device may sequentially output image data representing the purging of harmful gases from the chamber and the injection of nitrogen gas (e.g., 150 cc) in response to user inputs selecting buttons or popups such as “shut down,” “all gas purge,” “nitrogen injection,” “bypass,” and “operate.” Furthermore, based on the selection of a “gas evacuation” button, the device may output image data showing the evacuation of residual gases, the opening of the chamber lid, and the interior of the chamber.

The predefined simulation error information for the “etch rate abnormality” scenario may include at least one of: contamination inside the chamber or misalignment of the spiral tube.

Maintenance information corresponding to chamber contamination may include user action items related to removing particles and/or cleaning contaminants during the simulation. Maintenance information for a misaligned spiral tube may include user actions related to disassembling and reassembling the component.

In one embodiment, the electronic device may output image data showing chamber contamination as part of the monitoring data. For example, upon receiving user input indicating a touch on the chamber wall, the device may output image data showing stains or floating particles. The electronic device may then receive user inputs corresponding to maintenance actions—such as removing particles using an air gun or cleaning contamination with ethanol wipes—which match the predefined maintenance information.

In one embodiment, the electronic device may output image data indicating misalignment of the spiral tube as part of the monitoring data for the “etch rate abnormality” scenario. For example, based on user input selecting buttons for “Quartz parts removal” and “Depo kit removal,” the device may sequentially output image data showing the disassembly of quartz parts, separation of the depo kit into an upper depo shield, a middle depo shield, and a bottom exhaust plate, and an error associated with the spiral tube in the exhaust plate. Alternatively, the device may display a popup indicating the misalignment of the spiral tube. The electronic device may receive user input for disassembling and reassembling components (e.g., quartz parts, depo kit) as simulation maintenance input corresponding to the maintenance information.

The electronic device may include at least part of the above-described simulation error information and corresponding maintenance information (i.e., simulation error information-maintenance information pairs) in the target scenario. If the user input for simulation maintenance corresponds to the maintenance information for the target scenario (“etch rate abnormality”), the electronic device may terminate the target scenario. In one embodiment, if the target scenario includes multiple simulation error information-maintenance information pairs, the device may terminate the scenario upon receiving user input corresponding to all associated maintenance information.

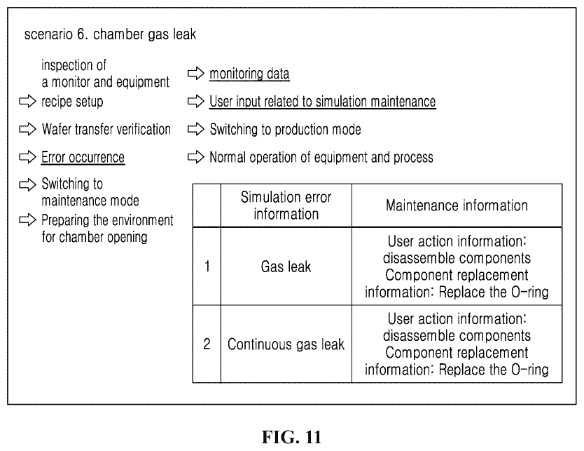

Referring to FIG. 11, the target scenario may correspond to a “chamber gas leak.” For example, the electronic device may output visual data (e.g., text or image data) indicating that a gas leak has occurred during the etching process. The device may switch from production mode to maintenance mode based on user input (e.g., selection of a “maintenance” button).

Based on user inputs selecting buttons or popups for “gas leak test” (e.g., etcher chamber leak test), “chamber open,” and “part removal” (e.g., quartz parts, depo kit, shutter), the electronic device may sequentially output image data showing the detection of gas leakage, the opening of the chamber lid, disassembly of the quartz parts, depo kit, and shutter, and the O-ring of the separated shutter shaft.

In one embodiment, the preset simulation error information for the “chamber gas leak” scenario may include at least one of a gas leak or a continuous gas leak.

Maintenance information corresponding to a gas leak may include user action information related to semiconductor process simulation, such as a user-selectable option to disassemble components, and virtual equipment component replacement information, such as a user-selectable option to replace an O-ring.

Maintenance information for a continuous gas leak may likewise include a user-selectable option for disassembling components and a user-selectable option for replacing an O-ring in the virtual simulation.

In one embodiment, the electronic device may output image data indicating gas leakage as monitoring data for the “chamber gas leak” scenario. For example, based on user input selecting options such as a gas leak test, opening the chamber, and removing components such as quartz parts, a depo kit, or a shutter, the device may sequentially display image data representing the detection of gas leakage, the opening of the chamber lid, the removal of the quartz parts, depo kit, and shutter, and the separated shutter shaft with the O-ring.

The electronic device may receive user input for simulation maintenance indicating that the user has disassembled components such as the quartz parts, depo kit, and shutter, and replaced the O-ring, which corresponds to the maintenance information. The electronic device may also receive user input indicating that the shutter was opened and closed after the O-ring replacement, followed by a selection input to execute the gas leak test again.

In one embodiment, the electronic device may output image data indicating a continuous gas leak as monitoring data for the “chamber gas leak” scenario. For example, the electronic device may output numerical data and/or text data indicating that the gas leakage issue has not been resolved. Based on user input selecting a button or popup to disassemble components such as the quartz parts and the electrostatic chuck (ESC), the electronic device may sequentially display image data showing the removal of the quartz parts and the ESC, followed by the separated ESC (or chuck) with the O-ring.

The electronic device may receive user input for simulation maintenance indicating that the user has disassembled components such as the quartz parts and ESC, replaced the O-ring, and reassembled the components, which corresponds to the maintenance information. The electronic device may also receive user input for simulation maintenance indicating that after the O-ring replacement, the user selected a button for “pin movement,” followed by selecting a button or popup to perform the “gas leak test” again.

The electronic device may include at least part of the above-described simulation error information and maintenance information (or simulation error information-maintenance information pairs) in the target scenario. If user input for simulation maintenance corresponds to the maintenance information of the target scenario (“chamber gas leak”), the electronic device may terminate the target scenario. In one embodiment, when the target scenario includes multiple simulation error information-maintenance information pairs, the electronic device may terminate the target scenario when all corresponding user inputs for simulation maintenance have been received.

In the scenarios illustrated in FIGS. 6 through 11, the electronic device may terminate the target scenario when user input for simulation maintenance satisfies the maintenance conditions of the target scenario. After terminating the target scenario, the electronic device may return to the production mode of the semiconductor process simulation. Based on user input indicating a request to switch to the production mode, such as the selection of a “Production” button, the electronic device may transition from the maintenance mode back to the production mode. In the production mode, the electronic device may output visual data indicating the normal operation of the semiconductor process simulation. For example, the electronic device may output visual data indicating the normal state of the virtual equipment used in the semiconductor process simulation, including external or internal views of replaced or adjusted components, process steps, or the manufactured product.

1. A method performed by an electronic device, the method comprising:
outputting monitoring data of a target scenario among one or more predetermined scenarios related to simulation errors in a production mode of a semiconductor process simulation, based on test data input by a user;
switching from the production mode of the semiconductor process simulation to a maintenance mode; and
terminating the target scenario in response to receiving the user input related to simulation maintenance that satisfies a maintenance condition of the target scenario while in the maintenance mode.

2. The method of claim 1,
wherein the monitoring data of the target scenario includes visual data related to predetermined simulation error information of the target scenario.

3. The method of claim 2,
wherein the visual data includes numerical data, image data, or text data representing the predetermined simulation error information of the target scenario.

4. The method of claim 1,
wherein each of the one or more predetermined scenarios includes predetermined simulation error information and maintenance information corresponding to the simulation error information.

5. The method of claim 4,
wherein the maintenance information includes test data information corresponding to a parameter related to the semiconductor process simulation.

6. The method of claim 4,
wherein the maintenance information includes component replacement information of virtual equipment related to the semiconductor process simulation.

7. The method of claim 4,
wherein the maintenance information includes component adjustment information of virtual equipment related to the semiconductor process simulation.

8. The method of claim 4,
wherein the maintenance information includes user action information related to the semiconductor process simulation.

9. The method of claim 1,
wherein the operation of terminating the target scenario when the user input related to simulation maintenance satisfies the maintenance condition of the target scenario includes terminating the target scenario when the user input corresponds to the maintenance information of the target scenario.

10. The method of claim 1,
further comprising:
switching back to the production mode of the semiconductor process simulation after terminating the target scenario; and
outputting visual data indicating a normal operation of the semiconductor process simulation in the production mode.

11. A non-transitory computer-readable recording medium storing one or more programs comprising instructions,
wherein when the instructions are executed individually or collectively by at least one processor of an electronic device, the instructions cause the electronic device to:
output monitoring data of a target scenario among one or more predetermined scenarios related to simulation errors, in a production mode of semiconductor process simulation based on user input-based test data;
switch from the production mode to a maintenance mode of the semiconductor process simulation; and
terminate the target scenario when a user input related to simulation maintenance satisfies a maintenance condition of the target scenario.

12. An electronic device comprising:
at least one processor including processing circuitry; and
a memory including one or more storage media storing instructions,
wherein when the instructions are executed individually or collectively by the at least one processor, the instructions cause the electronic device to:
output monitoring data of a target scenario among one or more predetermined scenarios related to simulation errors, in a production mode of semiconductor process simulation based on user input-based test data;
switch from the production mode to a maintenance mode of the semiconductor process simulation; and
terminate the target scenario when a user input related to simulation maintenance satisfies a maintenance condition of the target scenario.
